(19) United States
(12) Patent Application Publication
(10) Pub. No.: US 2013/0179844 A1
(43) Pub. Date: Jul. 11, 2013

(54) Input Pointer Delay

(71) Applicants: Mirko Mandic, Seattle, WA (US); Michael J. Ens, Redmond, WA (US); Justin E. Rogers, Redmond, WA (US)

(72) Inventors: Mirko Mandic, Seattle, WA (US); Michael J. Ens, Redmond, WA (US); Justin E. Rogers, Redmond, WA (US)

(21) Appl. No.: 13/345,552

(22) Filed: Jan. 6, 2012

(51) Int. Cl. G06F 3/033

(52) U.S. Cl. 715/863

(57) ABSTRACT

Various embodiments enable repetitive gestures, such as multiple serial gestures, to be implemented efficiently so as to enhance the user experience. In at least some embodiments, a first gesture associated with an object is detected. The first gesture is associated with a first action. Responsive to detecting the first gesture, pre-processing associated with the first action is performed in the background. Responsive to detecting a second gesture associated with the object within a pre-defined time period, an action associated with the second gesture is performed. Responsive to the second gesture not being performed within the pre-defined time period, processing associated with the first action is completed.

### BACKGROUND

The use of gestures has gained in popularity in connection with various computing devices. Challenges continue to face those who develop gesture-based technology insofar as enhancing the user experience and making gesture-based implementations more efficient.

### SUMMARY

This Summary is provided to introduce a selection of concepts in a simplified form that are further described below in the Detailed Description. This Summary is not intended to identify key features or essential features of the claimed subject matter.

Various embodiments enable repetitive gestures, such as multiple serial gestures, to be implemented efficiently so as to enhance the user experience.

In at least some embodiments, a first gesture associated with an object is detected. The first gesture is associated with a first action. Responsive to detecting the first gesture, pre-processing associated with the first action is performed in the background. Responsive to detecting a second gesture associated with the object within a pre-defined time period, an action associated with the second gesture is performed. Responsive to the second gesture not being performed within the pre-defined time period, processing associated with the first action is completed.

In at least some other embodiments, a first tap associated with an object is detected and a timer is started. Responsive to detecting the first tap, a style that has been defined for an element of which the object is a type is applied. Responsive to detecting a second tap within a time period defined by the timer, an action associated with a gesture comprising the first and second taps is performed. Responsive to not detecting a second tap within the time period defined by the timer, an action associated with the first tap is performed.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 is a flow diagram that describes steps of a method in accordance with one or more embodiments.

FIG. 4 is a flow diagram that describes steps of a method in accordance with one or more embodiments.

FIG. 5 is a flow diagram that describes steps of a method in accordance with one or more embodiments.

FIG. 6 illustrates an example computing device that can be utilized to implement various embodiments described herein.

### DETAILED DESCRIPTION

Overview

Various embodiments enable repetitive gestures, such as multiple serial gestures, to be implemented efficiently so as to enhance the user experience.

In at least some embodiments, a first gesture associated with an object is detected. The first gesture is associated with a first action. Responsive to detecting the first gesture, pre-processing associated with the first action is performed in the background. Responsive to detecting a second gesture associated with the object within a pre-defined time period, an action associated with the second gesture is performed. Responsive to the second gesture not being performed within the pre-defined time period, processing associated with the first action is completed.

In at least some other embodiments, a first tap associated with an object is detected and a timer is started. Responsive to detecting the first tap, a style that has been defined for an element of which the object is a type is applied. Responsive to detecting a second tap within a time period defined by the timer, an action associated with a gesture comprising the first and second taps is performed. Responsive to not detecting a second tap within the time period defined by the timer, an action associated with the first tap is performed.

In the following discussion, an example environment is first described that is operable to employ the techniques described herein. Example illustrations of the various embodiments are then described, which may be employed in the example environment, as well as in other environments. Accordingly, the example environment is not limited to performing the described embodiments and the described embodiments are not limited to implementation in the example environment.

Example Operating Environment

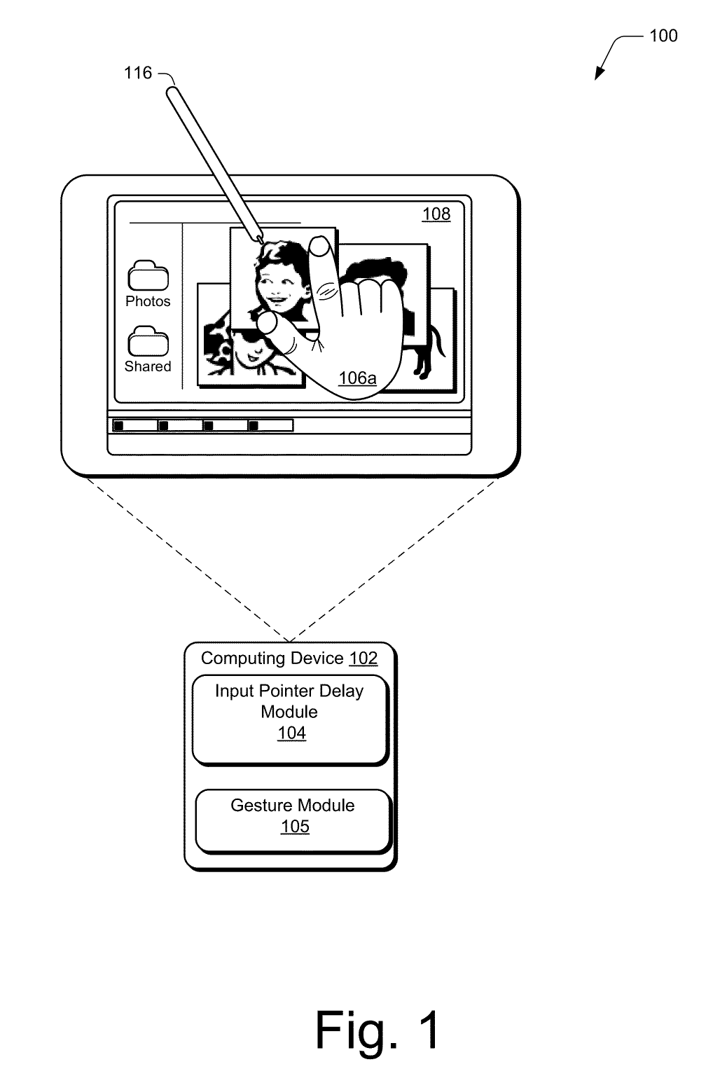

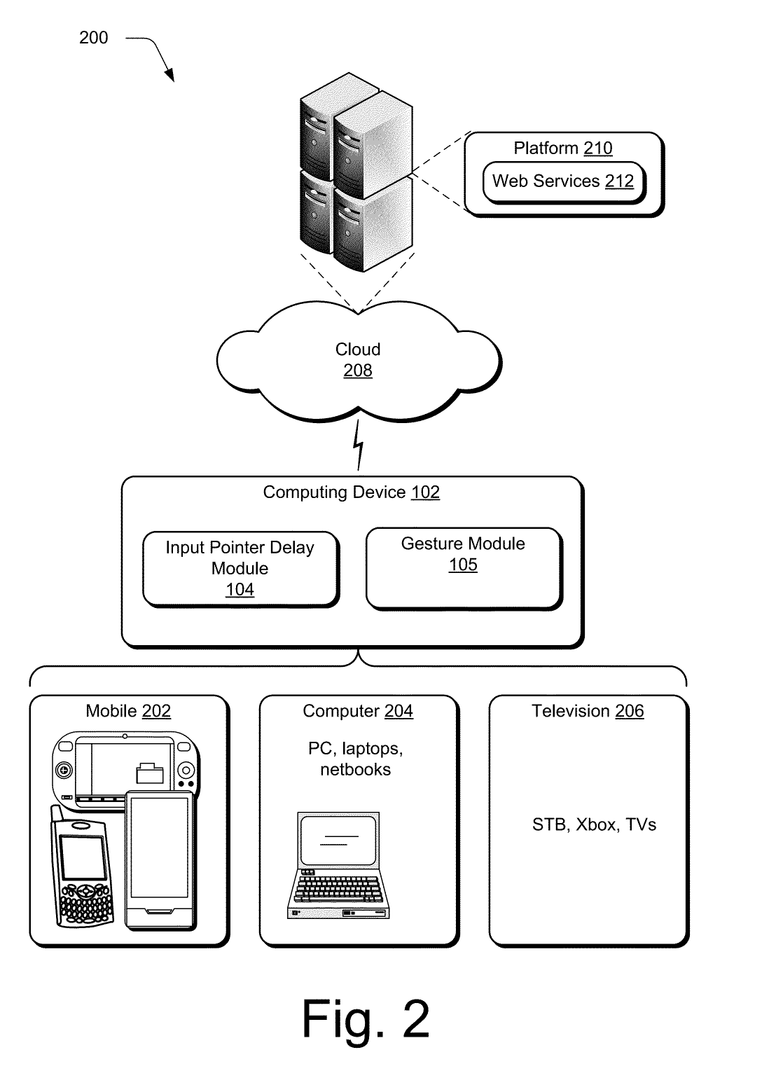

FIG. 1 is an illustration of an environment 100 in an example implementation that is operable to employ the input pointer delay techniques described in this document. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

Computing device 102 includes an input pointer delay module 104 configured to enable repetitive gestures, such as multiple serial gestures, to be implemented efficiently so as to enhance the user experience. The input pointer delay module 104 can make use of a timer to measure the time between multiple serial gestural inputs. Given the type and timing of the gestural inputs, actions associated with a first of the gestures and/or one or more of subsequent gestures or combinations thereof can be performed.

Computing device 102 also includes a gesture module 105 that recognizes input pointer gestures that can be performed by one or more fingers, and causes operations or actions to be performed that correspond to the gestures. The gestures may be recognized by module 105 in a variety of different ways. For example, the gesture module 105 may be configured to recognize a touch input, such as a finger of a user's hand 106a as proximal to display device 108 of the computing device 102 using touchscreen functionality. Module 105 can be utilized to recognize single-finger gestures and bezel gestures, multiple-finger/same-hand gestures and bezel gestures, and/or multiple-finger/different-hand gestures and bezel gestures. Although the input pointer delay module 104 and gesture module 105 are depicted as separate modules, the functionality provided by both can be implemented in a single, integrated gesture module. The functionality implemented by modules 104 and/or 105 can be implemented by any suitably configured application such as, by way of example and not limitation, a web browser.

The computing device 102 may also be configured to detect and differentiate between a touch input (e.g., provided by one or more fingers of the user's hand 106a) and a stylus input (e.g., provided by a stylus 116). The differentiation may be performed in a variety of ways, such as by detecting an amount of the display device 108 that is contacted by the finger of the user's hand 106a versus an amount of the display device 108 that is contacted by the stylus 116.

Thus, the gesture module 105 may support a variety of different gesture techniques through recognition and leverage of a division between stylus and touch inputs, as well as different types of touch inputs.

FIG. 2 illustrates an example system 200 showing the input pointer delay module 104 and gesture module 105 as being implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 202, computer 204, and television 206 uses. Each of these configurations has a generally corresponding screen size and thus the computing device 102 may be configured as one of these device classes in this example system 200. For instance, the computing device 102 may assume the mobile 202 class of device which includes mobile telephones, music players, game devices, and so on. The computing device 102 may also assume a computer 204 class of device that includes personal computers, laptop computers, netbooks, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the computing device 102 via the Internet or other networks.

The gesture techniques supported by the input pointer delay module 104 and gesture module 105 may be detected using touchscreen functionality in the mobile configuration 202, track pad functionality of the computer 204 configuration, detected by a camera as part of support of a natural user interface (NUI) that does not involve contact with a specific input device, and so on. Further, performance of the operations to detect and recognize the inputs to identify a particular gesture may be distributed throughout the system 200, such as by the computing device 102 and/or the web services 212 supported by the platform 210 of the cloud 208.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

In the discussion that follows, various sections describe various example embodiments. A section entitled “Example Input Pointer Delay Embodiments” describes embodiments in which an input pointer delay can be employed in accordance with one or more embodiments. Following this, a section entitled “Implementation Example” describes an example implementation in accordance with one or more embodiments. Last, a section entitled “Example Device” describes aspects of an example device that can be utilized to implement one or more embodiments.

Having described example operating environments in which the input pointer delay functionality can be utilized, consider now a discussion of an example embodiments.

Example Input Pointer Delay Embodiments

In the examples about to be described, two different approaches are described which, in at least some embodiments, may be employed together. The first approach utilizes background pre-processing in connection with receiving multiple serial gestures to mitigate the negative impact, as perceived by the user, of an input pointer delay. The second approach, which may or may not be used in connection with the first approach, is designed to provide concurrent user feedback to a user who is interacting with a resource such as a webpage. Each approach is discussed under its own separate sub-heading, followed by a discussion of an approach that combines both the first and second approaches.

### Background Pre-Processing

### Example

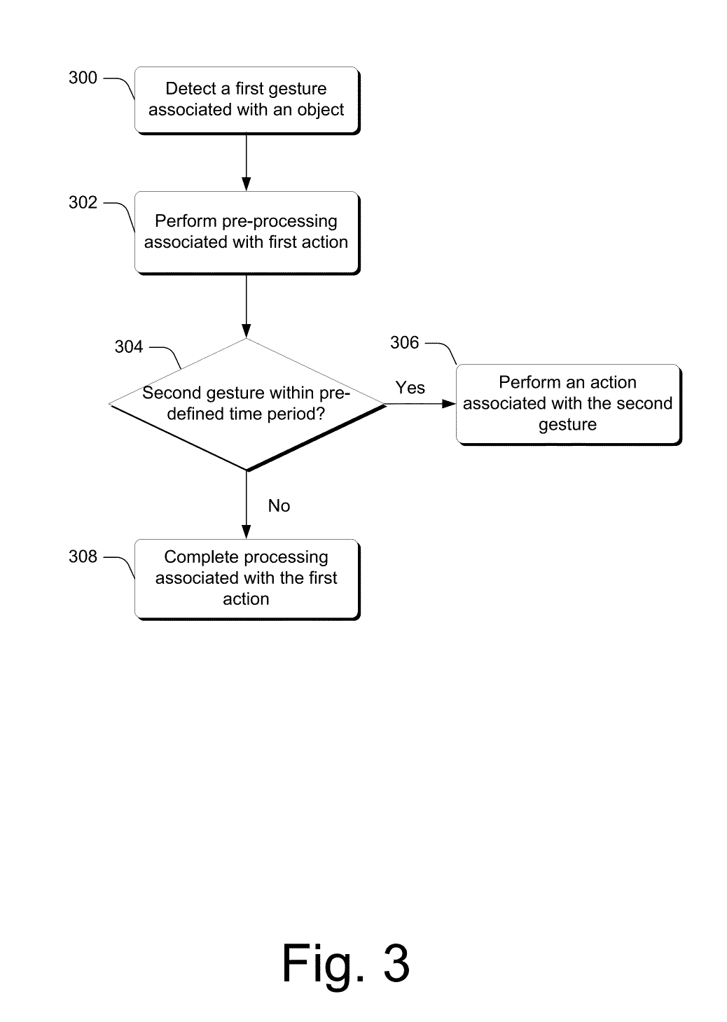

FIG. 3 is a flow diagram that describes steps in a method accordance with one or more embodiments. The method can be performed in connection with any suitable hardware, software, firmware, or combination thereof. In at least some embodiments, the method can be performed by software in the form of computer readable instructions, embodied on some type of computer-readable storage medium, which can be performed under the influence of one or more processors. Examples of software that can perform the functionality about to be described are the input pointer delay module 104 and the gesture module 105 described above.

Step 300 detects a first gesture associated with an object. The first gesture is associated with a first action that can be performed relative to the object. Any suitable type of gesture can be detected. By way of example and not limitation, the first gesture can comprise a touch gesture, a tap gesture, or any suitable other type of gesture as described above. In addition, any suitable type of first action can be associated with the first gesture. For example, in at least some embodiments, the first action comprises a navigation that can be performed to navigate from one resource, such as a webpage, to another resource, such as a different webpage. Responsive to detecting the first gesture, step 302 performs pre-processing associated with the first action. In one or more embodiments, pre-processing is performed in the background so as to be undetectable by the user. Any suitable type of pre-processing can be performed including, by way of example and not limitation, initiating downloading of one or more resources. For example, assume that the object comprises a hyperlink or some other type of navigable resource. The pre-processing, in this instance, can include downloading one or more resources associated with performing the navigation.

Step 304 ascertains whether a second gesture is detected within a pre-defined time period. Any suitable pre-defined time period can be utilized. In at least some embodiments, the pre-defined time period is equal to or less than about 300 ms. Further, any suitable type of second gesture can be utilized. By way of example and not limitation, the second gesture can comprise a touch gesture, a tap gesture, or any suitable other type of gesture as described above.

Responsive to detecting the second gesture associated with the object within a pre-defined time period, step 306 performs an action associated with the second gesture. In at least some embodiments, the action can be associated with the gesture that includes both the first and second gestures. Any suitable type of action can be associated with the second gesture. By way of example and not limitation, such actions can include performing a zoom operation in which the object is zoomed up. In this case, the pre-processing performed by step 302 can be discarded.

Alternately, responsive to the second gesture not being performed within the pre-defined time period, step 308 completes processing associated with the first action. This step can be performed in any suitable way. By way of example and not limitation, completion of the processing can include performing a navigation associated with the object and the resource or resources for which downloading was initiated during pre-processing.

In at least some embodiments, as will become apparent below, in addition to performing the pre-processing as described above, responsive to detecting the first gesture, one or more styles that are defined for an element of which the object is a type can be applied. Any suitable type of styles can be applied including, by way of example and not limitation, styles that are defined by a CSS pseudo-class. For example, styles associated with the :hover and/or :active pseudo-classes can be applied. As will be appreciated by the skilled artisan, such styles can be used to change an element's display properties such as the size, shape, color of an element, or to change a display background, initiate a position change, provide an animation or transition, and the like. For example, if a hyperlink normally changes colors or is underlined when selected by virtue of a defined style, such style can be applied when the first gesture is detected at step 300.

Having described how background pre-processing can be performed in accordance with one or more embodiments, consider now how concurrent user feedback can be provided in accordance with one or more embodiments.

### Concurrent User Feedback

### Example

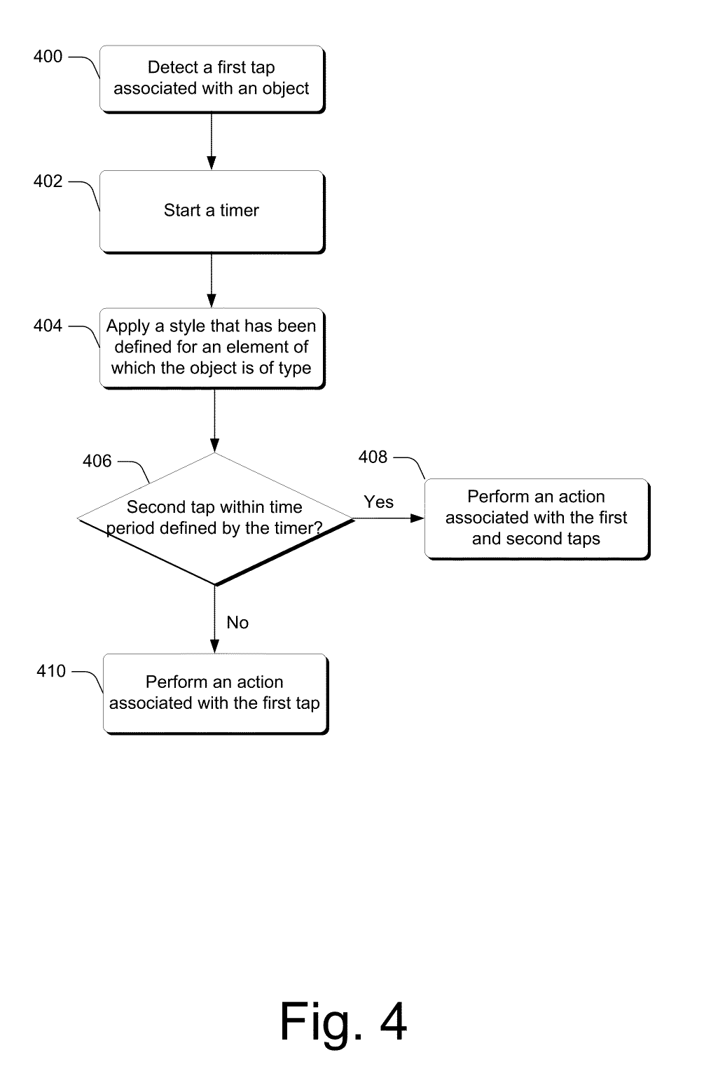

FIG. 4 is a flow diagram that describes steps in a method accordance with one or more embodiments. The method can be performed in connection with any suitable hardware, software, firmware, or combination thereof. In at least some embodiments, the method can be performed by software in the form of computer readable instructions, embodied on some type of computer-readable storage medium, which can be performed under the influence of one or more processors. Examples of software that can perform the functionality about to be described are the input pointer delay module 104 and the gesture module 105 described above.

Step 400 detects a first tap associated with an object. Responsive to detecting the first tap, step 402 starts a timer. Responsive to detecting the first tap, step 404 applies a style that has been defined for an element of which the object is of type. Any suitable type of style or styles can be applied including, by way of example and not limitation, styles that are defined by a CSS pseudo-class. For example, styles associated with the :hover and/or :active pseudo-classes can be applied.

Step 406 ascertains whether a second tap is detected within a time period defined by the timer. Any suitable time period can be utilized. In at least some embodiments, the time period can be equal to or less than about 300 ms. Responsive to detecting the second tap within the time period defined by the timer, step 408 performs an action associated with a gesture comprising the first and second taps. Any suitable action can be performed. In at least some embodiments, the action associated with the gesture comprising the first and second taps comprises a zoom operation.

Responsive to not detecting a second tap within the time period defined by the timer, step 410 performs an action associated with the first tap. Any suitable action can be performed. In at least some embodiments, the action associated with the first tap comprises performing a navigation.

In at least some embodiments, within the time period defined by the timer, pre-processing associated with performing the action associated with the first tap can be performed. Any suitable type of pre-processing can be performed. In at least some embodiments, pre-processing can include, by way of example and not limitation, initiating downloading of one or more resources. In this instance, the action associated with the first tap can comprise a navigation associated with the downloaded resource or resources.

Having considered embodiments that employ concurrent user feedback, consider now an approach that utilizes both background pre-processing and concurrent user feedback in accordance with one or more embodiments.

### Background Pre-Processing and Concurrent User Feedback

### Example

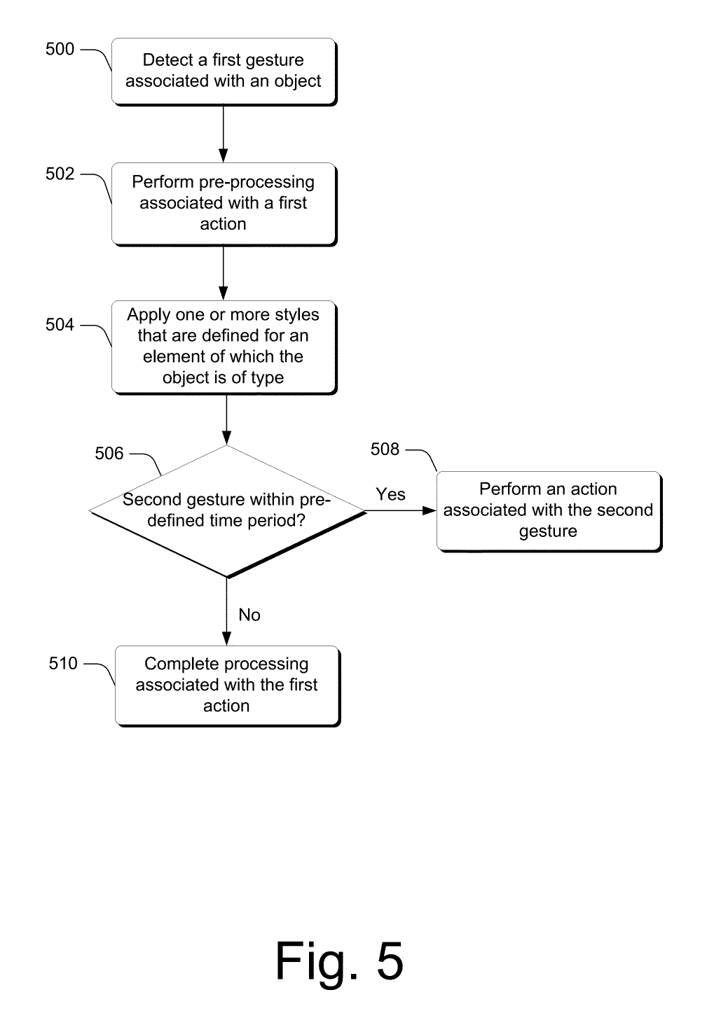

FIG. 5 is a flow diagram that describes steps in a method accordance with one or more embodiments. The method can be performed in connection with any suitable hardware, software, firmware, or combination thereof. In at least some embodiments, the method can be performed by software in the form of computer readable instructions, embodied on some type of computer-readable storage medium, which can be performed under the influence of one or more processors. Examples of software that can perform the functionality about to be described are the input pointer delay module 104 and the gesture module 105 described above.

Step 500 detects a first gesture associated with an object. The first gesture is associated with a first action that can be performed relative to the object. Any suitable type of gesture can be detected. By way of example and not limitation, the first gesture can comprise a touch gesture, a tap gesture, or any suitable other type of gesture as described above. In addition, any suitable type of first action can be associated with the first gesture. For example, in at least some embodiments, the first action comprises a navigation that can be performed to navigate from one resource, such as a webpage, to another resource, such as a different webpage. Responsive to detecting the first gesture, step 502 performs pre-processing associated with the first action in the background. Any suitable type of pre-processing can be performed including, by way of example and not limitation, initiating downloading of one or more resources. For example, assume that the object comprises a hyperlink or some other type of navigable resource. The pre-processing, in this instance, can include downloading one or more resources associated with performing the navigation.

Step 504 applies one or more styles that are defined for an element of which the object is a type. Examples of how this can be done are provided above. Step 506 ascertains whether a second gesture is detected within a pre-defined time period. Responsive to detecting the second gesture within the predefined time period, step 508 performs an action associated with the second gesture. In at least some embodiments, the action can be associated with a gesture that includes both the first and second gestures. In at least some embodiments, the first and second gestures can comprise a tap gesture. Any suitable type of action can be associated with the second gesture. By way of example and not limitation, such action can include performing a zoom operation in which the object is zoomed up. In this case, the pre-processing performed by step 502 can be discarded.

Alternately, responsive to the second gesture not being performed within the pre-defined time period, step 510 completes processing associated with the first action. This step can be performed in any suitable way. By way of example and not limitation, completion of the processing can include performing a navigation associated with the object and the resource or resources for which downloading was initiated during pre-processing.

Having considered some example methods, consider now an implementation example.

### Implementation Example

In one or more embodiments, the functionality described above can be implemented by delaying input pointer events. One way to do this is as follows. When an input is received such as a tap from a gesture, a pen tap, a mouse click, input from a natural user interface (NUI) and the like, a timer is set to a predefined time such as, by way of example and not limitation, 300 ms. A double tap caching component is utilized and input messages are re-routed to the double tap caching component. In addition, a preliminary message is sent to a selection component to perform selection-related logic without delay. The functionality performed by the selection-related component can be performed, in the above examples, by the input pointer delay module 104. Selection-related logic can include selecting text that was tapped, un-selecting text that was previously tapped, launching a context menu because already-selected text has been tapped, and the like.

In one or more embodiments, pseudo-classes such as :active and :hover would already have been applied by normal input processing because a tap is composed of a touch-down and a touch-up, and :active and :hover are applied during touch-down, before a tap is recognized. This also means that the webpage would have seen some events leading up to the tap.

The double tap caching component examines the previously-sent message and performs the following logic. First, the component ascertains whether the input is caused by a touch with the primary contact (i.e., a touch with one finger). If not, then the input is processed as usual. This allows things such as mouse interactions to continue in an unimpeded manner.

If, on the other hand, the input is caused by a touch with the primary contact, the logic continues and ascertains whether such is a new contact. If the input is not a new contact, then a corresponding message is appended to an internal deferred messages queue and ignored for the time being. Any information that can only be gathered at the time a message is received is gathered and stored in this queue, e.g., whether the touch came from physical hardware or was simulated. If, on the other hand, the contact is a new contact the logic continues as described below.

The logic now ascertains whether the location of the new contact is close enough to a previously-detected tap to be considered a double tap. If not, this is treated the same as a timeout. When a timeout occurs, if the element that was originally tapped still exists, then every input message in the deferred messages queue is processed immediately, in order, thus completing a delayed tap. An exception is that these messages are hidden from the selection manager because actions associated with the selection manager have already been performed.

If the location of the new contact is close enough to the previously-detected tap to be considered a double tap, the logic ascertains whether the originally-tapped element still exists. If the originally-tapped element still exists, a “pointer cancel” event is sent through the document object model (DOM) and :active and :hover are removed to indicate to the webpage that saw the first half of the tap that no more of the tap will be forthcoming. Whether or not the element still exists, the logic continues as described below.

Next, any text on the page is unselected which effectively undoes the previous selection. At this point, a double tap zoom operation is performed and all messages in the deferred messages queue are discarded so that the webpage never sees them.

Having described an example implementation, consider now a discussion of an example device that can be utilized to implement the embodiments described above.

Example Device

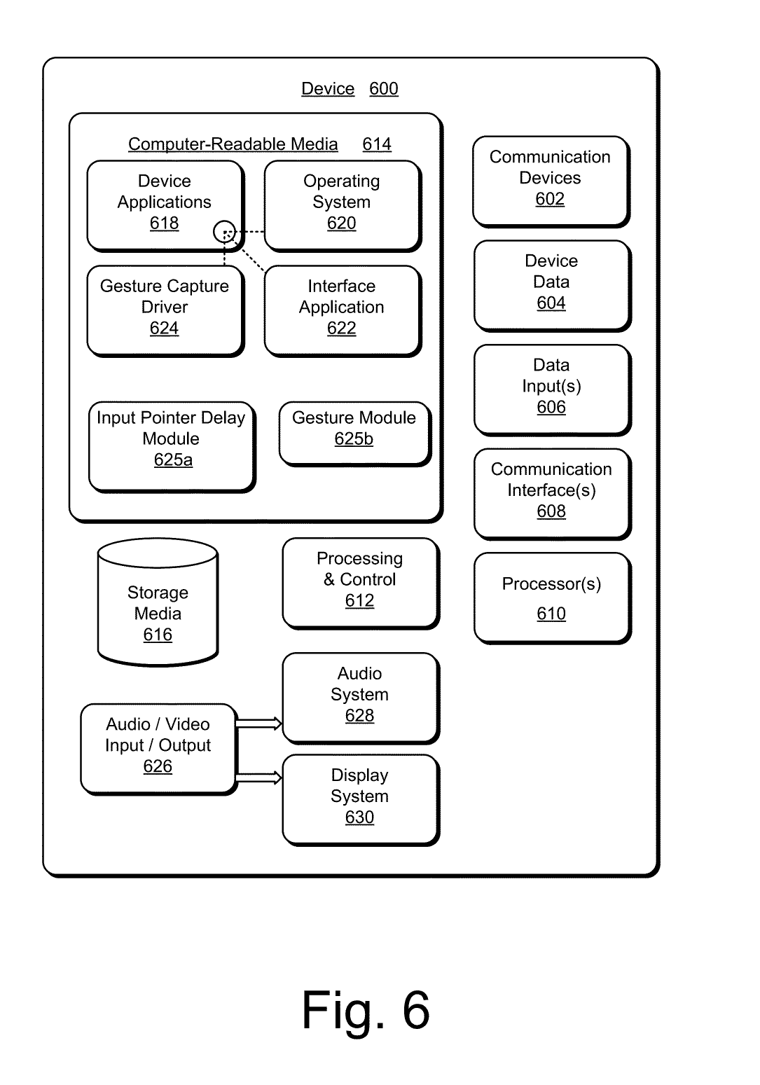

FIG. 6 illustrates various components of an example device 600 that can be implemented as any type of portable and/or computer device as described with reference to FIGS. 1 and 2 to implement embodiments of the animation library described herein. Device 600 includes communication devices 602 that enable wired and/or wireless communication of device data 604 (e.g., received data, data that is being received, data scheduled for broadcast, data packets of the data, etc.). The device data 604 or other device content can include configuration settings of the device, media content stored on the device, and/or information associated with a user of the device. Media content stored on device 600 can include any type of audio, video, and/or image data. Device 600 includes one or more data inputs 606 via which any type of data, media content, and/or inputs can be received, such as user-selectable inputs, messages, music, television media content, recorded video content, and any other type of audio, video, and/or image data received from any content and/or data source.

Device 600 also includes communication interfaces 608 that can be implemented as any one or more of a serial and/or parallel interface, a wireless interface, any type of network interface, a modem, and as any other type of communication interface. The communication interfaces 608 provide a connection and/or communication links between device 600 and a communication network by which other electronic, computing, and communication devices communicate data with device 600.

Device 600 includes one or more processors 610 (e.g., any of microprocessors, controllers, and the like) which process various computer-executable or readable instructions to control the operation of device 600 and to implement the embodiments described above. Alternatively or in addition, device 600 can be implemented with any one or combination of hardware, firmware, or fixed logic circuitry that is implemented in connection with processing and control circuits which are generally identified at 612. Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600 also includes computer-readable media 614, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 600 can also include a mass storage media device 616.

Computer-readable media 614 provides data storage mechanisms to store the device data 604, as well as various device applications 618 and any other types of information and/or data related to operational aspects of device 600. For example, an operating system 620 can be maintained as a computer application with the computer-readable media 614 and executed on processors 610. The device applications 618 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 618 also include any system components or modules to implement embodiments of the techniques described herein. In this example, the device applications 618 include an interface application 622 and a gesture-capture driver 624 that are shown as software modules and/or computer applications. The gesture-capture driver 624 is representative of software that is used to provide an interface with a device configured to capture a gesture, such as a touchscreen, track pad, camera, and so on. Alternatively or in addition, the interface application 622 and the gesture-capture driver 624 can be implemented as hardware, software, firmware, or any combination thereof. In addition, computer readable media 614 can include an input pointer delay module 625a and a gesture module 625b that functions as described above.

Device 600 also includes an audio and/or video input-output system 626 that provides audio data to an audio system 628 and/or provides video data to a display system 630. The audio system 628 and/or the display system 630 can include any devices that process, display, and/or otherwise render audio, video, and image data. Video signals and audio signals can be communicated from device 600 to an audio device and/or to a display device via an RF (radio frequency) link, S-video link, composite video link, component video link, DVI (digital video interface), analog audio connection, or other similar communication link. In an embodiment, the audio system 628 and/or the display system 630 are implemented as external components to device 600. Alternatively, the audio system 628 and/or the display system 630 are implemented as integrated components of example device 600.

### CONCLUSION

Various embodiments enable repetitive gestures, such as multiple serial gestures, to be implemented efficiently so as to enhance the user experience.

In at least some embodiments, a first gesture associated with an object is detected. The first gesture is associated with a first action. Responsive to detecting the first gesture, pre-processing associated with the first action is performed in the background. Responsive to detecting a second gesture associated with the object within a pre-defined time period, an action associated with the second gesture is performed. Responsive to the second gesture not being performed within the pre-defined time period, processing associated with the first action is completed.

In at least some other embodiments, a first tap associated with an object is detected and a timer is started. Responsive to detecting the first tap, a style that has been defined for an element of which the object is a type is applied. Responsive to detecting a second tap within a time period defined by the timer, an action associated with a gesture comprising the first and second taps is performed. Responsive to not detecting a second tap within the time period defined by the timer, an action associated with the first tap is performed.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A method comprising:
detecting a first gesture associated with an object, the first gesture being associated with a first action;
responsive to detecting the first gesture, performing pre-processing associated with the first action in the background;
responsive to detecting a second gesture associated with the object within a pre-defined time period, performing an action associated with at least the second gesture; and
responsive to the second gesture not being performed within the pre-defined time period, completing processing associated with the first action.

2. The method of claim 1, wherein the first gesture comprises a tap gesture.

3. The method of claim 1, wherein the first and second gestures comprise tap gestures.

4. The method of claim 1, wherein the pre-defined time period is equal to or less than about 300 ms.

5. The method of claim 1, wherein the performing the pre-processing comprises initiating downloading of one or more resources.

6. The method of claim 1, wherein the performing the pre-processing comprises initiating downloading of one or more resources, the completing processing comprising performing a navigation associated with the one or more resources.

7. The method of claim 1 further comprising responsive to detecting the first gesture, applying one or more styles that are defined for an element of which the object is a type.

8. The method of claim 1 further comprising responsive to detecting the first gesture, applying one or more styles that are defined for an element of which the object is a type, the one or more styles being defined by a CSS pseudoclass.

9. One or more computer readable storage media embodying computer readable instructions which, when executed, implement a method comprising:
detecting a first tap associated with an object;
starting a timer;
responsive to detecting the first tap, applying a style that has been defined for an element of which the object is a type;
responsive to detecting a second tap within a time period defined by the timer, performing an action associated with a gesture comprising the first and second taps; and
responsive to not detecting a second tap within the time period defined by the timer, performing an action associated with the first tap.

10. The one or more computer readable storage media of claim 9, wherein the action associated with the gesture comprising the first and second taps comprises a zoom operation.

11. The one or more computer readable storage media of claim 9, wherein performing the action associated with the first tap comprises performing a navigation.

12. The one or more computer readable storage media of claim 9 further comprising, within the time period defined by the timer, performing pre-processing associated with performing the action associated with the first tap.

13. The one or more computer readable storage media of claim 9 further comprising, within the time period defined by the timer, performing pre-processing associated with performing the action associated with the first tap, the performing preprocessing comprising initiating downloading of one or more resources.

14. The one or more computer readable storage media of claim 9 further comprising, within the time period defined by the timer, performing pre-processing associated with performing the action associated with the first tap, the performing preprocessing comprising initiating downloading of one or more resources, the action associated with the first tap comprising a navigation associated with the one or more resources.

15. The one or more computer readable storage media of claim 9, wherein the style is defined by a CSS pseudoclass.

16. The one or more computer readable storage media of claim 9, wherein the style is defined by a CSS pseudoclass, the CSS pseudoclass comprising at least one of an :active pseudoclass or :hover pseudoclass.

17. A system comprising:
one or more processors;
one or more computer readable storage media;
computer readable instructions embodied on the one or more computer readable storage media which, when executed under the influence of the one or more processors, implement a method comprising:
detecting a first gesture associated with an object, the first gesture being associated with a first action;
responsive to detecting the first gesture, performing pre-processing associated with the first action in the background and applying one or more styles that are defined for an element of which the object is a type;
responsive to detecting a second gesture associated with the object within a pre-defined time period, performing an action associated with the second gesture; and
responsive to the second gesture not being performed within the pre-defined time period, completing processing associated with the first action.

18. The system of claim 17, wherein at least one of the first or second gestures comprises a tap.

19. The system of claim 17, wherein the performing the pre-processing comprises initiating downloading of one or more resources.

20. The system of claim 17, wherein the one or more styles are defined by a CSS pseudoclass.
